(19) United States
(12) Patent Application Publication
(10) Pub. No.: US 2004/0145317 A1
(43) Pub. Date: Jul. 29, 2004

(54) Display panel and method for manufacturing the same

(75) Inventors: Taro Naoi, Yamanashi-ken (JP); Tomoyuki Nakatani, Yamanashi-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Pioneer Corporation

(21) Appl. No.: 10/756,255

(22) Filed: Jan. 14, 2004

(30) Foreign Application Priority Data
Jan. 16, 2003 (JP) 2003-8201

(51) Int. Cl. H01J 17/49; H01J 9/00; H01J 9/24

(52) U.S. Cl. 313/587; 313/582; 313/586; 445/24

(57) ABSTRACT

A method for manufacturing a display panel, in which a protective layer (MgO layer) for a dielectric layer covering row electrode pairs is formed on a first substrate, then the first substrate is placed opposite a second substrate, having required structures formed thereon, to define a discharge space between them, then the discharge space is sealed, and then the discharge space is filled with a discharge gas, has the steps of; placing the first substrate with the protective layer (MgO layer) in a reducing gas atmosphere; and producing a discharge in the reducing gas atmosphere for dry-etching a surface of the protective layer (MgO layer).

### BACKGROUND OF THE INVENTION

1. Field of the Invention

This invention relates to a display panel and a method for manufacturing the display panel.

The present application claims priority from Japanese Application No. 2003-8201, the disclosure of which is incorporated herein by reference.

2. Description of the Related Art

FIG. 1 is a vertical section view illustrating the panel structure of an AC-driven, reflection type plasma display panel (hereinafter referred to as “PDP”).

The PDP includes a front substrate 1 having row electrode pairs (X, Y), a dielectric layer 2 which covers the row electrode pairs (X, Y), and a protective layer 3 which is made of MgO or the like and covers the dielectric layer 2 formed on the inner surface. Each of the row electrode pairs (X, Y) is constituted of paired row electrodes X and Y, and each row electrode X, Y is constituted of a transparent electrode Xa, Ya made of ITO or the like and a bus electrode Xb, Yb formed of a thick film electrode made of silver or the like.

The PDP includes a back substrate 4 having the inner surface opposing the inner surface of the front substrate 1. On the inner surface of the back substrate 4 are formed column electrodes D each extending in a direction intersecting the row electrode pairs (X, Y) so as to form discharge cells C at the intersections with the row electrode pairs (X, Y) in a discharge space S; a column-electrode protective layer 5 covering the column electrodes D; phosphor layers 6 formed on the column-electrode protective layer 5 and individually having one of the colors, red, green and blue, applied thereto in each discharge cell C; and a partition wall (not shown) for partitioning the discharge space S into the discharge cells C.

The inside of the discharge space S is filled with a gas mixture of neon Ne and 5% to 20% xenon Xe as a discharge gas.

The phosphor layer 6 is excited by vacuum ultraviolet light (wavelength 147 nm) emitted from the Xe gas by a discharge, thereby emitting visible light.

FIG. 2 is a flow chart for describing a conventional manufacturing process for the PDP structured as described hitherto.

In process s1 for producing the front substrate in FIG. 2, the row electrodes X and Y are formed on the front substrate 1 by the use of photolithograph techniques or the like, then the dielectric layer 2 is formed by the use of screen printing techniques or the like, and then the protective layer (MgO layer) 3 is formed (process sla).

In process s2 for producing the back substrate, the column electrodes D are formed on the back substrate 4 by the use of photolithograph techniques or the like, then the column-electrode protective layer 5 is formed by the use of screen printing techniques or the like, and then the partition wall is formed in turn by the use of sandblasting techniques or the like. After that, a phosphor paste is applied between wall portions of the partition wall and fired to form the phosphor layer 6 (process s2a).

Then, sealing glass frit is coated onto the periphery edge of the surface of the back substrate facing the front substrate and then fired at a temperature of about 400 degrees C. so as to form a sealing layer. After that, the front substrate 1 and the back substrate 4 are placed opposite each other such that the row electrode pairs (X, Y) formed on the front substrate land the column electrodes D formed on the back substrate 4 are positioned at right angles to each other.

Then, the opposed front and back substrates 1 and 4 are baked at a temperature of about 450 degrees C., and the sealing layer formed on the back substrate 4 is fused to the front substrate 1 to seal the periphery of the discharge space S formed between the back substrate 4 and the front substrate 1 (process s3).

After that, air is removed from the discharge space S under the conditions of baking at a temperature of about 350 degrees C. (process s4). Then, after the front and back substrates 1 and 4 have cooled, the discharge gas is infused into the discharge space S at a predetermined pressure (400 Torr to 600 Torr) (process s5).

After the completion of the infusion of the discharge gas, an air-exchanging tube used when removing the air and infusing the discharge gas is sealed (process s6).

Then, a drive pulse is applied between the row electrodes X and Y provided as a pair on the front substrate for a predetermined time period to generate a discharge for activation (aging) of the protective layer (MgO layer) 3 formed on the front substrate 1 and for stabilization of the discharges (process s7).

The discharge properties in the PDP structured as described above are typically dependent to a large degree on the conditions for the formation of the protective layer (MgO layer) 3, the film quality of the protective layer (MgO layer) 3 so formed, and the like.

For this reason, the manufacturing of high-quality PDPs requires the establishment of the best conditions for the formation of the protective layer (MgO layer) 3 and an improvement in film quality.

Further, a further reduction in the cost of the PDP is required for the purpose of making the PDPs more widely available to households.

However, the conventional method of manufacturing PDPs as described above is incapable of complying with such requirements for the PDPs.

### SUMMARY OF THE INVENTION

This invention is made to solve the problems associated with the conventional manufacturing process for the display panels as described hitherto.

Accordingly it is an object of the present invention to provide display panels capable of being produced with high quality and achieving cost reduction.

To attain this object, a first aspect of the present invention provides a method for manufacturing a display panel in which a protective layer for a dielectric layer covering row electrode pairs is formed on a first substrate, then the first substrate is placed opposite a second substrate having required structures formed thereon to define a discharge space between them, then the discharge space is sealed, and then the discharge space is filled with a discharge gas. This method of manufacturing the display panel has the feature of the steps of placing the first substrate in a reducing gas atmosphere after the protective layer has been formed on the first substrate, and generating a discharge in the reducing gas atmosphere for dry-etching the surface of the protective layer.

In the method of manufacturing the display panel of the first aspect, prior to sealing the discharge space defined between the first and second substrates placed opposite each other, the protective layer formed on the first substrate is dry-etched by means of a discharge caused in the reducing gas atmosphere. This method allows removal of moisture and/or the other impurities that adhere to the protective layer which have resulted from the exposure of the first substrate to the atmospheric air after the protective layer has been formed on the first substrate. Further, a layer resulting from a bond between e.g. H₂ included in the reducing gas and MgO in the protective layer is formed on the surface of the protective layer, so that the secondary electron-releasing power of the protective layer is significantly improved. This makes it possible to increase the luminous efficiency as compared with that in the conventional display panels, and the like, resulting in a significant enhancement of the panel performance.

Further, the surface condition of the protective layer is reformed and thus the photoelectric effect is increased, resulting in the possibilities of the improved performance (luminous efficiency, margin and the like) of the display and an extended range of choices of drive sequences for the display.

Still further, because of the dry etching treatment for the protective layer, the surface of the protective layer is cleaned prior to the steps of sealing the discharge space, of removing air from the discharge space and of baking. Hence, it is possible to shorten the process time period required for the baking process, thereby reducing the manufacturing costs of the PDPs.

To attain the aforementioned object, a second aspect of the present invention provides a method for manufacturing a display panel in which a protective layer for a dielectric layer covering row electrode pairs is formed on a first substrate, then the first substrate is placed opposite a second substrate having required structures formed thereon to form a discharge space between the first and second substrates, then the discharge space is sealed, then a baking process for heating during removal of air from the discharge space is performed, then a discharge-gas filling process for filling the discharge space with discharge gas is performed, and then a process for generating a discharge in the discharge space is performed to achieve aging. This method of manufacturing the display panel has the feature of performing, between the baking process and the discharge-gas filling process, an aging process for infusing a reducing gas into the discharge gas and then producing a discharge in the discharge space with use of the row electrode pairs formed on the first substrate.

In the method of manufacturing the display panel in the second aspect, after sealing the discharge space defined between the first and second substrates placed opposite each other, and prior to filling the discharge space with a discharge gas, a reducing gas is infused into the discharge space, and then a discharge is produced in the reducing gas atmosphere to achieve aging, thereby removing moisture and/or the other impurities that still adhere to the surface of the protective layer of the first substrate after the completion of the process of sealing the discharge space and the baking process. In addition to this removal, a layer of a bond between MgO and e.g. H₂ included in the reducing gas is formed on the surface of the protective layer, resulting in a significant improvement in the secondary electron-releasing power of the protective layer.

Further, because the protective layer formed on the first substrate is aged prior to the infusion of the discharge gas into the discharge space, the surface of the protective layer is cleaned to make it possible to shorten the process time required for another aging process performed posterior to the aging concerned, and also to omit a process for air-firing the protective layer, leading to a further reduction of the manufacturing cost of the PDPs.

To attain the aforementioned object, a third aspect of the present invention provides a display panel including a first substrate having a dielectric layer formed thereon to cover row electrode pairs, a second substrate having required structures formed thereon and placed opposite the first substrate, and a discharge space defined between the opposed first and second substrates and filled with a discharge gas. The display panel has the feature in which a protective layer is formed for the dielectric layer on the first substrate and a surface of the protective layer is dry-etched by means of a discharge produced in a reducing gas atmosphere after the protective layer has been formed on the first substrate.

The display panel in the third aspect is significantly enhanced in its panel performance by an increased luminous efficiency and the like as compared with those in the conventional display panels. This is because, in the manufacturing process for the display panel, a discharge is produced in a reducing gas atmosphere in order to dry-etch the surface of the protective layer, which has been formed on the first substrate, for the removal of the adhesion of moisture and/or the other impurities to the protective layer which have resulted from the exposure of the first substrate with the protective layer to the atmospheric air, and also for the formation of a layer of a bond between e.g. H₂ included in the reducing gas and MgO in the protective layer on the surface of the protective layer, so that the secondary electron-releasing power of the protective layer is significantly improved.

Further, the reform of the surface condition of the protective layer gives rise to an increase of the photoelectric effect. For this reason, the performance (luminous efficiency, margin and the like) of the display panel is improved and the range of choices of drive sequences for the display panel is extended.

Still further, because of the dry etching treatment for the protective layer, cleaning of the surface of the protective layer is achieved prior to the steps of sealing the discharge space, removing air from the discharge space and baking. This makes it possible to shorten the process time period required for the baking process, and therefore to manufacture the display panels at low cost.

To attain the aforementioned object, a fourth aspect of the present invention provides a display panel including a first substrate having a dielectric layer formed thereon to cover row electrode pairs, a second substrate having required structures formed thereon and placed opposite the first substrate, and a discharge space defined between the opposed first and second substrates and filled with a discharge gas. The display panel has the feature in which a protective layer is formed for the dielectric layer on the first substrate and a surface of the protective layer on the first substrate is aged by means of a discharge produced in an atmosphere of a reducing gas infused into the discharge space in a stage before the discharge gas is infused into the discharge space.

The display panel in the fourth aspect is significantly improved in the secondary electron-releasing power of the protective layer. This is because, in the manufacturing process of the display panel, posterior to sealing the discharge space defined between the first and second substrates placed opposite each other, and prior to filling the discharge space with a discharge gas, a reducing gas is infused into the discharge space, and then a discharge is produced in the reducing gas atmosphere to perform aging. Thereupon, this aging allows removal of moisture and/or the other impurities that still adhere to the surface of the protective layer of the first substrate after the completion of the process of sealing the discharge space and the baking process. Further, a layer of a bond between e.g. H₂ included in the reducing gas and MgO is formed on the surface of the protective layer.

Further, because the protective layer formed on the first substrate undergoes aging prior to the infusion of the discharge gas into the discharge space, the surface of the protective layer is cleaned, and thus it is possible to shorten the process time required for performing the aging process posterior to the aging concerned, and also to omit a process for air-firing the protective layer, leading to a further reduction of the manufacturing cost of the display panels.

These and other objects and features of the present invention will become more apparent from the following detailed description with reference to the accompanying drawings.

### BRIEF DESCRIPTION OF THE DRAWINGS

FIG. 1 is a sectional view illustrating a typical structure of a plasma display panel.

FIG. 2 is a process flow chart describing a conventional method for manufacturing a plasma display panel.

FIG. 3 is a process flow chart describing a first embodiment of a method for manufacturing a display panel according to the present invention.

FIG. 4 is a schematic block diagram illustrating a plasma-etching device used in the first embodiment.

FIG. 5 is a table illustrating a condition of a dry-etching process.

FIG. 6 is a graph illustrating the comparison of the photoelectric effects produced on the MgO layer surface by dry-etching in the first embodiment.

FIG. 7 is a graph illustrating the comparison of the work functions produced on the MgO layer surface by dry-etching in the first embodiment.

FIG. 8 is a process flow chart describing a second embodiment of a method for manufacturing a display panel according to the present invention.

FIG. 9 is a diagram illustrating a process of infusing a reducing gas in the second embodiment.

### DETAILED DESCRIPTION OF THE PREFERRED EMBODIMENTS

Preferred embodiments according to the present invention will be described below in detail with reference to the accompanying drawings.

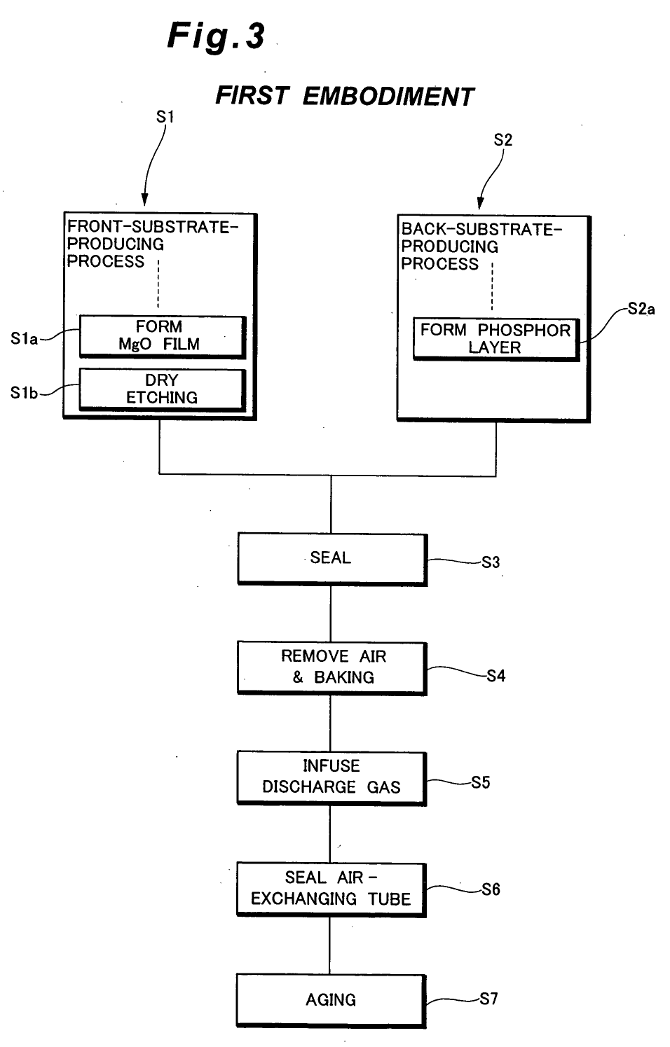

FIG. 3 is a process flow chart illustrating a first embodiment of a method for manufacturing a display panel according to the present invention.

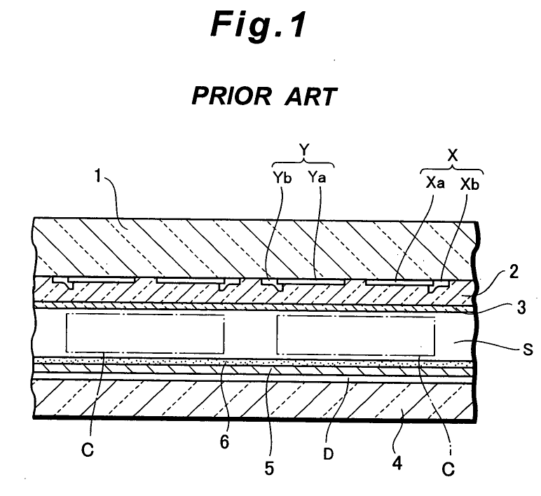

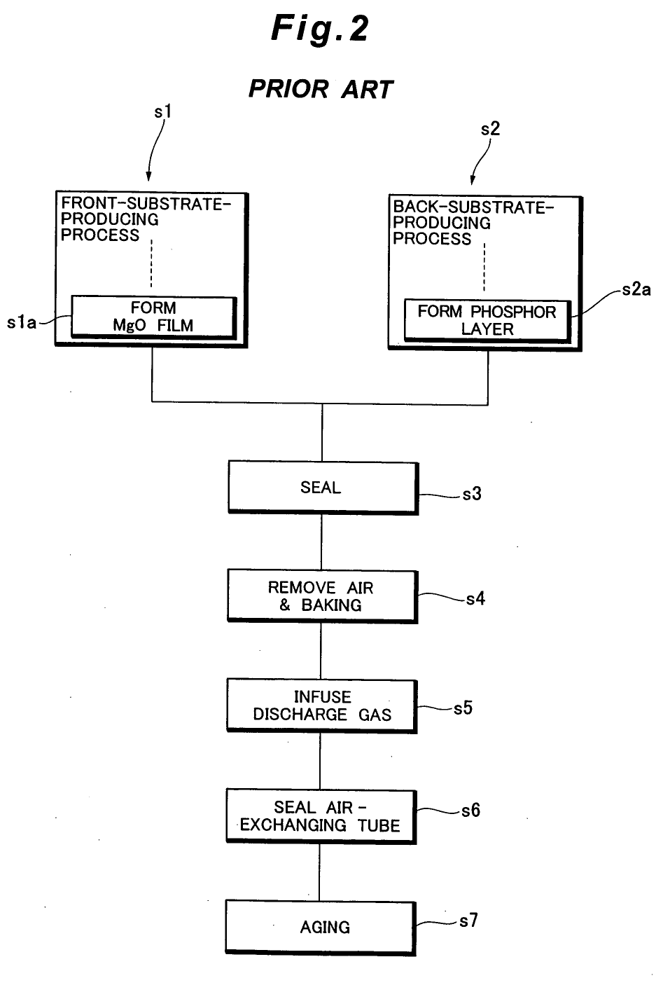

The manufacturing method described in FIG. 3 includes a process S1 for producing a front substrate in which the row electrode pairs (X, Y) are formed on the front substrate 1 of a plasma display panel (PDP) by the use of photolithograph techniques or the like, the dielectric layer 2 is formed by the use of screen printing techniques or the like so as to cover the row electrode pairs (X, Y), and further the protective layer (MgO layer) 3 is formed on the dielectric layer 2 and covers the back surface thereof (process S1a) (see FIG. 1).

For formation of the protective layer (MgO layer) 3, E-beam vapor deposition techniques, sputtering techniques, ion plating techniques, or the like are used.

After that, the dry-etching treatment is performed on the protective layer (MgO layer) 3 formed on the front substrate (process S1b).

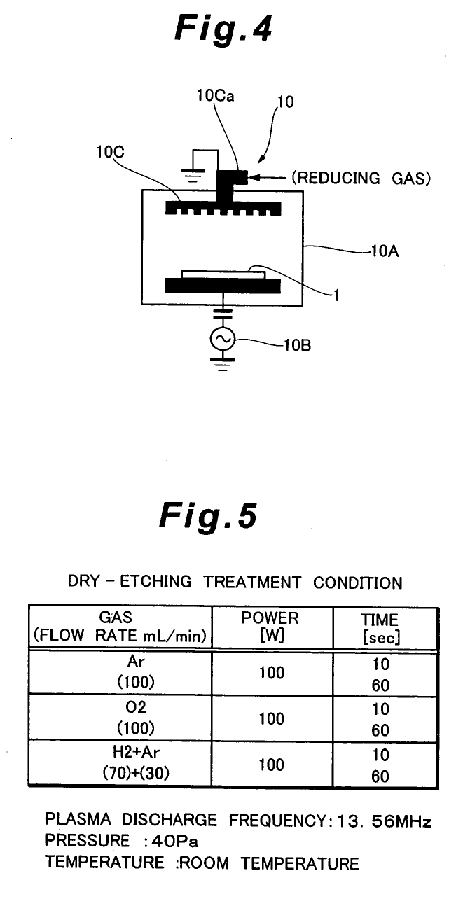

For performing the dry-etching process for the protective layer (MgO layer) 3, a plasma-etching device 10 as illustrated in FIG. 4 is used.

The plasma-etching device 10 includes a vacuum chamber 10A for receiving the front substrate 1 having undergone the processes for forming the row electrode pairs (X, Y), dielectric layer 2 and protective layer (MgO layer) 3; an AC power source 10B; and a discharge electrode 10C earthed and having an infusing port 10Ca for the reducing gas.

In the dry-etching process S1b, the front substrate 1 having the row electrode pairs (X, Y), dielectric layer 2 and protective layer (MgO layer) 3 formed thereon is loaded parallel opposite to the discharge electrode 10C in the vacuum chamber 10A and the row electrode pairs (X, Y) are connected to the ac power source 10B.

After the air is removed from the inside of the vacuum chamber 10A, a reducing gas including H₂ is infused from the infusing port 10Ca of the discharge electrode 10C into the vacuum chamber 10A.

Then, voltage is applied from the ac power source 10B to the row electrode pairs (X, Y) on the front substrate 1 to cause a plasma discharge between the row electrode pairs (X, Y) and the discharge electrode 10C in an atmosphere of the reducing gas discharge.

The physical dry etching effected by the plasma discharge enables removal of the adhesions of moisture and/or the other impurities to the protective layer (MgO layer) 3 which have resulted from the exposure of the front substrate 1 to the atmospheric air after the protective layer (MgO layer) 3 has been formed. The physical dry etching also yields a significant improvement in the secondary electron-releasing power (y) of the protective layer (MgO layer) 3, as will be described later, because a layer resulting from a bond between MgO and H₂ included in the reducing gas is formed on the surface of the protective layer (MgO layer) 3.

In process S2 for producing the back substrate, the column electrodes D are formed on the back substrate 4 by the use of photolithograph techniques or the like. Further the column-electrode protective layer 5 covering the column electrodes D is formed by the use of screen printing techniques or the like. The partition wall is then formed on the column-electrode protective layer 5 by the use of sandblasting techniques or the like. A phosphor paste is then applied between wall portions of the partition wall and fired to form the phosphor layer 6 (process S2a) (see FIG. 1).

After the completion of the front-substrate-producing process S1 and the back-substrate-producing process S2 as described hitherto, sealing glass frit is coated onto the periphery edge of the surface of the back substrate 4 facing the front substrate 1 and then fired in order to form a sealing layer. Then the front substrate 1 and the back substrate 4 are placed opposite to each other such that the row electrode pairs (X, Y) formed on the front substrate 1 and the column electrodes D formed on the back substrate 4 are positioned at right angles to each other.

Then, the opposed front and back substrates 1 and 4 are baked in a baking furnace, so that the sealing layer formed on the back substrate 4 is fused to the front substrate 1 to seal the periphery of the discharge space formed between the front substrate 1 and the back substrate 4 (process S3).

After that, an air-exchanging tube is connected and sealed to an air-exchanging port formed in the back substrate 4. During a baking process, the air is removed via the air-exchanging tube from the discharge space defined between the front substrate 1 and the back substrate 4 (process S4).

Upon the cooling of the front substrate 1 and the back substrate 4 after the completion of the air-removing and baking process S4, a discharge gas, e.g. a Ne—Xe gas, is infused via the air-exchanging tube, connected to the back substrate 4, into the discharge space at a predetermined pressure (process S5). After the completion of the infusion of the discharge gas, the air-exchanging tube is sealed (process S6).

Then, a drive pulse is applied between the row electrodes X and Y of the row electrode pairs (X, Y) on the front substrate for a predetermined time period to generate a discharge. As a result, activation (aging) of the protective layer (MgO layer) 3 formed on the front substrate 1 and stabilization of the discharges are achieved (process S7).

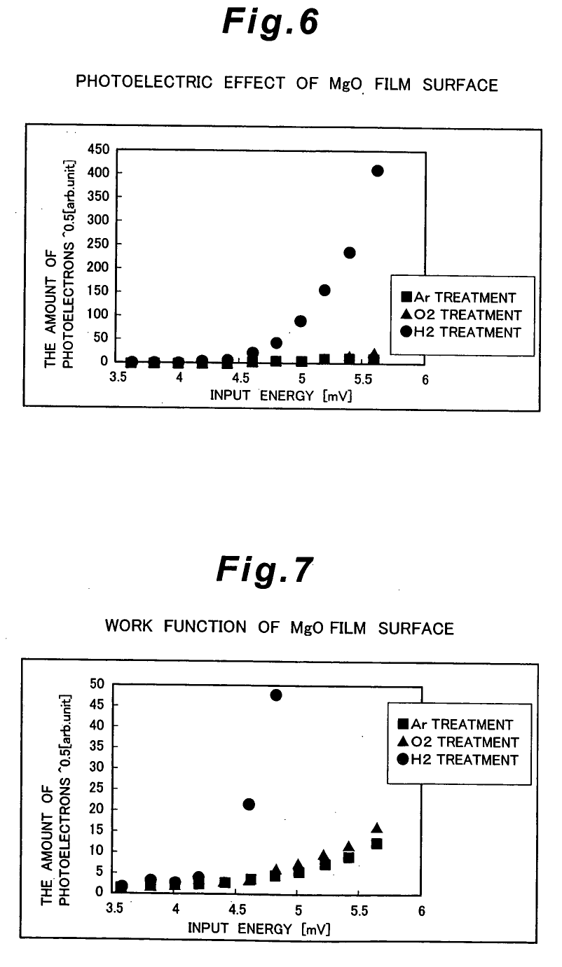

FIG. 5 shows an example of the processing conditions when Ar gas, O₂ gas and a gas mixture of H₂ and Ar are each used as the reducing gas for dry etching. FIG. 6 shows the comparison of the photoelectric effects in each gas in the surface of the protective layer (MgO layer) 3 on which the dry etching in the foregoing process S1b is performed under the processing conditions shown in FIG. 5. FIG. 7 shows the comparison of the work functions among the same.

It can be understood from FIGS. 6 and 7 that the use of H₂ gas (in this case, a mixture gas of H₂ and Ar) as the reducing gas dramatically increases the photoelectric effect (secondary electron-releasing power) in the surface of the protective layer (MgO layer) 3 and also reduces the work function as compared with the use of Ar gas and O₂ gas.

The dry etching of the protective layer (MgO layer) 3 may be performed by the use of microwave plasma techniques (2.45 GHz) as well as the RF plasma techniques (13.56 MHz) as described above.

With the method of manufacturing the PDPs as described hitherto, the physical dry etching effected by the plasma discharge is performed in a reducing gas atmosphere including H₂ on the protective layer (MgO layer) 3 immediately after the process S1a for forming the protective layer (MgO layer) 3 in the front-substrate-producing process S1. Thereby, the surface conditions of the protective layer (MgO layer) 3 are reformed, so that the photoelectric effect is increased, leading to an improvement in the performance of the PDP (luminous efficiency, margin and the like) and extension of the range of choices of drive sequences for the PDP.

Further, before starting the discharge-space sealing process S3 and the air-removing and baking process S4, the surface of the protective layer (MgO layer) 3 is cleaned because of the dry etching. This makes it possible to shorten the process time required for the air-removing and baking process S4, resulting in a reduction in manufacturing costs for the PDP.

The PDP manufactured by the foregoing manufacturing method has the panel performance significantly improved by increasing the luminous efficiency and the like as compared with those in conventional PDPs because the surface of the protective layer (MgO layer) 3 undergoes physical dry etching which is caused by a plasma discharge produced in an atmosphere of a reducing gas including H₂, and therefore the protective layer (MgO layer) 3 has a high secondary electron-releasing power (γ).

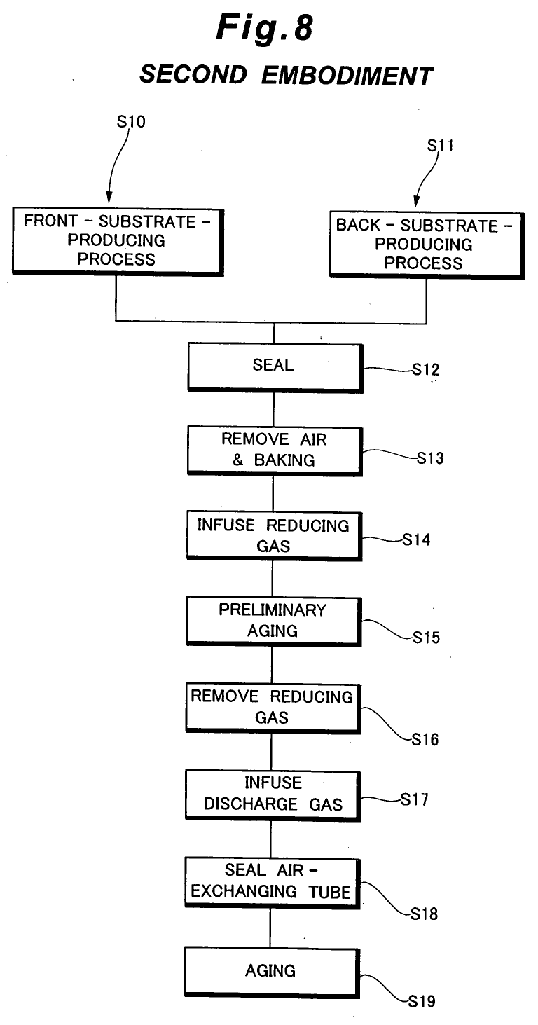

FIG. 8 is a process flow chart illustrating a second embodiment of a method for manufacturing a PDP in accordance with the present invention.

The manufacturing method in the second embodiment includes a front-substrate-producing process S10 in which the row electrode pairs (X, Y) are formed on the front substrate 1 by the use of photolithograph techniques or the like, and the dielectric layer 2 is formed so as to cover the row electrode pairs (X, Y) by the use of screen printing techniques or the like, and further the protective layer (MgO layer) 3 is formed on and covers the back surface of the dielectric layer 2 (see FIG. 1).

In a back-substrate-producing process S11, the column electrodes D are formed on the back substrate 4 by the use of photolithograph techniques or the like, then the column electrode protective layer 5 is formed so as to cover the column electrodes D by the use of screen printing techniques or the like, then the partition wall for partitioning the discharge space S is formed on the column electrode protective layer 5 by the use of sandblasting techniques or the like, and then the phosphor layers 6 are formed by applying a phosphor paste between wall portions of the partition wall and firing (see FIG. 1).

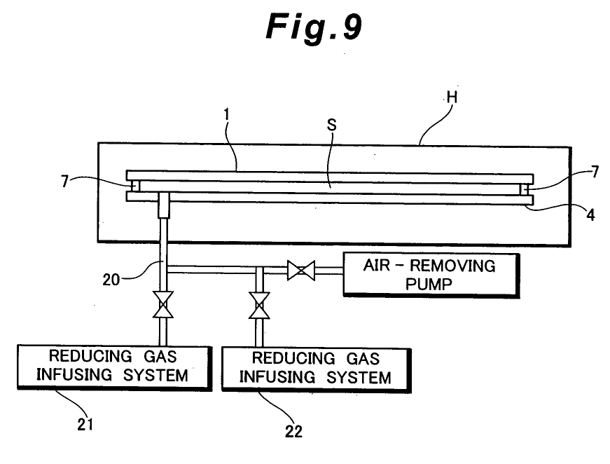

After the completion of the front-substrate-producing process S10 and back-substrate-producing process S11 as described hitherto, as described in FIG. 9, sealing glass frit is coated on to the periphery edge of the surface of the back substrate 4 facing the front substrate 1 and then fired to form a sealing layer 7 on the periphery edge. After that the front substrate 1 and the back substrate 4 are placed opposite each other such that the row electrode pairs (X, Y) formed on the front substrate 1 and the column electrodes D formed on the back substrate 4 are positioned at right angles to each other.

Then, the front and back substrates 1 and 4 thus opposed are baked in a baking furnace H. Thus, the sealing layer formed on the back substrate 4 is fused to the front substrate 1, resulting in a seal around the periphery of the discharge space S formed between the back substrate 4 and the front substrate 1 (process S12).

Then, an air-exchanging tube 20 is hermetically connected to an air-exchanging port formed in the substrate 4 for vacuum baking in which the air is removed via the air-exchanging tube 20 from the discharge space S under conditions of baking (process S13).

Upon the cooling of the front and back substrates 1 and 4 after the completion of the air-removing and baking process S13, a reducing gas mixed with H₂ gas is infused via the air-exchanging tube 20 from a reducing gas infusing system 21 (process S14). In this state, a drive pulse is applied between the row electrodes X and Y of the row electrode pair (X, Y) formed on the front substrate 1 for preliminary aging (process S15).

The preliminary aging allows removal of moisture and/or the other impurities still adhering to the surface of the protective layer (MgO layer) 3 of the front substrate 1 after the completion of the sealing process S12 and the air-removing and baking process S13. Further, because of the preliminary aging, a layer of a bond between MgO and H₂ in the reducing gases is formed on the surface of the protective layer (MgO layer) 3, thereby significantly improving the secondary electron-releasing power (γ) of the protective layer (MgO layer) 3.

The reducing gases are removed after completion of the preliminary aging process S15 (process S16).

After the completion of the process S16 for removing the reducing gases, a discharge gas, e.g. Ne—Xe gas, is infused at a predetermined pressure from a discharge gas infusing system 22 via the air-exchanging tube 20 into the discharge space S (process S17). The air-exchanging tube 20 is sealed after the completion of the infusion of discharge gas (process S18).

Then, a drive pulse is applied between the row electrodes X and Y of each row electrode pair (X, Y) on the front substrate 1 for a predetermine time period to produce a discharge in the discharge space S for achievement of aging (activation) of the protective layer (MgO layer) 3 formed on the front substrate land stabilization of the discharges (process S19).

In the method of manufacturing the PDP according to the second embodiment, prior to the process S17 for infusing the discharge gas into the discharge space S, the reducing gases mixed with H₂ gas is infused into the discharge space S and the preliminary aging is performed in the reducing gas atmosphere. Because of the steps of this method, the surface of the protective layer (MgO layer) 3 is cleaned, and therefore it is possible to shorten the process time required for the aging process S19 posterior to the preliminary aging, and also to omit a process for air-firing the protective layer (MgO layer) 3, leading to a further reduction in the manufacturing cost of the PDPs.

In the second embodiment, the reducing gases infused into the discharge space S in the process S14 may be mixed with Ar gas.

The method of manufacturing the displays according to the first embodiment is embodied on the superordinate idea of a method for manufacturing a display panel in which a protective layer for a dielectric layer covering row electrode pairs is formed on a first substrate; the first substrate is placed opposite a second substrate, having required structures formed thereon, to define a discharge space between them; and the discharge space is sealed and filled with a discharge gas, wherein after the protective layer has been formed on the first substrate, the first substrate with the protective layer is placed in a reducing gas atmosphere and a discharge is produced in the reducing gas atmosphere to dry-etch the surface of the protective layer.

In the method of manufacturing the displays forming the super-ordinate idea, prior to sealing the discharge space defined between the first and second substrates placed opposite each other, the protective layer formed on the first substrate is dry-etched by means of a discharge caused in the reducing gas atmosphere. This method allows removal of moisture and/or the other impurities that adhere to the protective layer because the first substrate is exposed to the atmospheric air after the protective layer has been formed on the first substrate. Further, a layer of a bond between e.g. H₂ included in the reducing gas and MgO in the protective layer is formed on the surface of the protective layer, so that the secondary electron-releasing power of the protective layer is significantly improved. This makes it possible to increase the luminous efficiency and the like as compared with those in the conventional displays, resulting in a significant enhancement of the panel performance.

Further, the surface condition of the protective layer is reformed and thus the photoelectric effect is increased, resulting in possibilities of the improved performance (luminous efficiency, margin and the like) of the display and an extended range of choices of drive sequences for the display.

Still further, because of the dry etching on the protective layer, the surface of the protective layer is cleaned prior to the steps of sealing the discharge space, removing air from the discharge space and baking. Hence, it is possible to shorten the-process time period required for the baking process, thereby reducing the manufacturing costs of the display panels.

The method of manufacturing the display panels according to the second embodiment is embodied on the superordinate idea of a method for manufacturing display panels in which a protective layer for a dielectric layer covering row electrode pairs is formed on a first substrate, then the first substrate is placed opposite a second substrate, having required structures formed thereon, to form a discharge space between the first and second substrates, then the discharge space is sealed, then a baking process for heating during removal of air from the discharge space is performed, then a discharge-gas filling process for filling the discharge space with a discharge gas is performed, and then a process for producing a discharge in the discharge space is performed to achieve aging, wherein after the baking process and before the discharge-gas filling process, an aging process for infusing a reducing gas into the discharge gas and then producing a discharge in the discharge space with use of the row electrode pairs formed on the first substrate is performed.

In the method of manufacturing the display forming the super-ordinate idea, posterior to sealing the discharge space defined between the first and second substrates placed opposite each other, and prior to filling the discharge space with a discharge gas, a reducing gas is infused into the discharge space, and then a discharge is produced in the reducing gas atmosphere to perform aging, thereby removing moisture and/or the other impurities that still adhere to the surface of the protective layer of the first substrate after the completion of the process of sealing the discharge space and the baking process. In addition to this removal, a layer of a bond between e.g. H₂ included in the reducing gas and MgO is formed on the surface of the protective layer, resulting in a significant improvement in the secondary electron-releasing power of the protective layer.

Further, because the protective layer formed on the first substrate undergoes aging prior to the infusion of the discharge gas into the discharge space, the surface of the protective layer is cleaned to make it possible to shorten the process time required for performing another aging process at a later time, and also to omit a process for air-firing the protective layer, leading to a further reduction of the manufacturing cost of the PDP.

The display panel manufactured by the method of manufacturing the display panels according to the first embodiment is a display panel on the superordinate idea that has a first substrate having a protective layer formed thereon for a dielectric layer covering row electrode pairs, a second substrate having required structures formed thereon and placed opposite the first substrate, and a discharge space defined between the opposed first and second substrates and filled with a discharge gas, in which the surface of the protective layer formed on the first substrate undergoes dry etching which is caused by a discharge produced in a reducing gas atmosphere after the protective layer has been formed on the first substrate.

The display panel forming the super-ordinate idea is significantly enhanced in its panel performance by an increased luminous efficiency and the like as compared with those in the conventional display panels. This is because, in the manufacturing process for the display panel, the surface of the protective layer formed on the first substrate undergoes dry etching which is caused by a discharge produced in a reducing gas atmosphere, so that the adhesion of moisture and/or the other impurities to the protective layer which has resulted from the exposure of the first substrate with the protective layer to the atmospheric air are removed, and further a layer of a bond between e.g. H₂ included in the reducing gas and MgO in the protective layer is formed on the surface of the protective layer. Hence, the secondary electron-releasing power of the protective layer is significantly improved.

Further, the surface condition of the protective layer is reformed and thus the photoelectric effect is increased, resulting in possibilities of the improved performance (luminous efficiency, margin and the like) of the display and an extended range of choices of drive sequences for the display.

Still further, because of the dry etching on the protective layer, the surface of the protective layer is cleaned prior to the steps of sealing the discharge space, removing air from the discharge space and baking. This makes it possible to shorten the process time period required for the baking process, leading to a reduction in the manufacturing costs of the display panels.

The display panel manufactured by the method of manufacturing the display panels according to the second embodiment is a display panel on the super-ordinate idea that has a first substrate having a protective layer formed thereon for a dielectric layer covering row electrode pairs, a second substrate having required structures formed thereon and placed opposite the first substrate, and a discharge space defined between the opposed first and second substrates and filled with a discharge gas, in which a surface of the protective layer formed on the first substrate undergoes aging caused by a discharge produced in an atmosphere of a reducing gas infused into the discharge space in a stage before the discharge gas is infused into the discharge space.

The display panel forming the super-ordinate idea is significantly improved in the secondary electron-releasing power of the protective layer. This is because, in the manufacturing process of the display panel, posterior to sealing the discharge space defined between the first and second substrates placed opposite each other, and prior to filling the discharge space with a discharge gas, a reducing gas is infused into the discharge space, and then a discharge is produced in the reducing gas atmosphere to perform aging. Then this aging allows removal of moisture and/or the other impurities that still adhere to the surface of the protective layer of the first substrate after the completion of the process of sealing the discharge space and the baking process. Further, a layer of a bond between e.g. H₂ included in the reducing gas and MgO is formed on the surface of the protective layer.

Further, because the protective layer formed on the first substrate undergoes aging prior to the infusion of the discharge gas into the discharge space, the surface of the protective layer is cleaned, and therefore it is possible to shorten the process time required for performing another aging process at a later time, and also to omit a process for air-firing the protective layer, leading to the manufacturing of the display panels at low cost.

The terms and description used herein are set forth by way of illustration only and are not meant as limitations. Those skilled in the art will recognize that numerous variations are possible within the spirit and scope of the invention as defined in the following claims.

What is claimed is:

1. A method for manufacturing a display panel in which a protective layer for a dielectric layer covering row electrode pairs is formed on a first substrate, then the first substrate is placed opposite a second substrate having required structures formed thereon to define a discharge space between the first and second substrates, then the discharge space is sealed, and then the discharge space is filled with a discharge gas, comprising the steps of:
placing the first substrate in an atmosphere of a reducing gas after the protective layer has been formed on the first substrate, and
producing a discharge in the atmosphere of the reducing gas for dry-etching a surface of the protective layer.

2. A method for manufacturing a display panel according to claim 1, wherein the reducing gas includes hydrogen gas.

3. A method for manufacturing a display panel according to claim 2, wherein the reducing gas further includes argon gas.

4. A method for manufacturing a display panel according to claim 1, wherein the discharge produced in the atmosphere of the reducing gas is a plasma discharge.

5. A method for manufacturing a display panel according to claim 1, wherein the surface of the protective layer of the first substrate is dry-etched by carrying out steps of:
placing the first substrate, having the protective layer formed thereon, in a vacuum chamber;
connecting the row electrodes, formed on the first substrate, to a power source;
infusing the reducing gas into the vacuum chamber; and
producing the discharge between the first substrate and a discharge electrode situated opposite the first substrate.

6. A method for manufacturing a display panel according to claim 1, wherein the protective layer is a MgO layer.

7. A method for manufacturing a display panel in which a protective layer for a dielectric layer covering row electrode pairs is formed on a first substrate, then the first substrate is placed opposite a second substrate having required structures formed thereon to form a discharge space between the first and second substrates, then the discharge space is sealed, then a baking process for heating during removal of air from the discharge space is performed, then a discharge-gas filling process for filling the discharge space with a discharge gas is performed, and then a process for producing a discharge in the discharge space is performed to achieve aging, comprising the steps of:
between the baking process and the discharge-gas filling process, an aging process for infusing a reducing gas into the discharge space and then producing a discharge in the discharge space with use of the row electrode pairs formed on the first substrate.

8. A method for manufacturing a display panel according to claim 7, wherein the reducing gas includes hydrogen gas.

9. A method for manufacturing a display panel according to claim 8, wherein the reducing gas further includes argon gas.

10. A method for manufacturing a display panel according to claim 7, wherein the discharge produced in the reducing gas atmosphere is a plasma discharge.

11. A method for manufacturing a display panel according to claim 7, wherein the protective layer is a MgO layer.

12. A display panel, including a first substrate having a dielectric layer formed thereon to cover row electrode pairs, a second substrate having required structures formed thereon and placed opposite the first substrate, and a discharge space defined between the opposed first and second substrates and filled with a discharge gas, comprising
a protective layer formed for the dielectric layer on the first substrate, and having a surface dry-etched by means of a discharge generated in a atmosphere of a reducing gas after the protective layer has been formed on the first substrate.

13. A display panel according to claim 12, wherein the reducing gas includes hydrogen gas.

14. A display panel according to claim 13, wherein the reducing gas further includes argon gas.

15. A display panel according to claim 12, wherein the discharge produced in the reducing gas atmosphere is a plasma discharge.

16. A display panel according to claim 12, wherein the protective layer is a MgO layer.

17. A display panel, including a first substrate having a dielectric layer formed thereon to cover row electrode pairs, a second substrate having required structures formed thereon and placed opposite the first substrate, and a discharge space defined between the opposed first and second substrates and filled with a discharge gas, comprising,
a protective layer formed for the dielectric layer on the first substrate, and having a surface aged by means of a discharge produced in an atmosphere of a reducing gas infused into the discharge space in a stage before the discharge gas is infused into the discharge space.

18. A display panel according to claim 17, wherein the reducing gas includes hydrogen gas.

19. A display panel according to claim 18, wherein the reducing gas further includes argon gas.

20. A display panel according to claim 17, wherein the discharge produced in the reducing gas atmosphere is a plasma discharge.

21. A display panel according to claim 17, wherein the protective layer is a MgO layer.
